(19) United States
(12) Patent Application Publication
(10) Pub. No.: US 2008/0128040 A1
(43) Pub. Date: Jun. 5, 2008

(54) Leadthrough

(75) Inventors: Manfred Klein, Kaufering (DE); Herbert Muenzenberger, Wiesbaden (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 11/985,833

(22) Filed: Nov. 16, 2007

(30) Foreign Application Priority Data
Dec. 1, 2006 (DE) 10 2006 035 474.5

(51) Int. Cl. F16L 5/00

(52) U.S. Cl. 138/103; 138/122; 52/220.8

(57) ABSTRACT

A leadthrough for passing conduits through constructional components includes a thread-forming thread (13) provided on an outer circumference (12) of a jacket tube (11) and extending from a first axial end region (15) toward a second axial end region (16), and a centering section (24) provided in the first axial end region (15) between the thread (13) and an end (25) of the jacket tube (11).

### BACKGROUND OF THE INVENTION

1. Field of the Invention

The present invention relates to a leadthrough for passing conduits such as, e.g., tubular conduits or cables, through a constructional component, e.g., through a ceiling or a wall, and including a jacket tube.

2. Description of the Prior Art

With leadthroughs of the type described above, the jacket or protective tube is inserted in an opening provided in a constructional component and encases the opening. A conduit can be passed through the jacket tube and be sealed against the jacket tube.

German Utility Model DE 200 04 118 U1 discloses a tubular building component which is used as a leadthrough in a concrete or breakwork and which has a wall tube on the outer surface or the outer circumference of which a multiple web seal that is formed of an elastomeric material, is secured.

The drawback of the known leadthrough consists in that it is only conditionally suitable for its insertion into a lightweight partition wall, e.g., formed of two, spaced from each other, building boards that are secured so that they form a package, because it can be fixed in an opening of the lightweight partition wall only using additional seals or securing means.

Accordingly, an object of the present invention is to provide a leadthrough for constructional components that are easily mountable and are particularly suitable for a subsequent insertion in lightweight partition walls.

### SUMMARY OF THE INVENTION

This and other objects of the present invention, which will become apparent hereinafter, are achieved by providing a leadthrough having a thread-forming thread provided on an outer circumference of the jacket tube. The thread has a thread height and extends from a first axial end region toward a second axial end region. A centering section is provided in the first axial end region between the thread and a first end of the jacket tube.

The centering section can be formed thread-free or can have an ascending thread section the thread height of which ascends toward the thread provided on the jacket tube. Thereby, the inventive jacket tube can be easily centered in a pre-formed opening in a constructional component, e.g., in a lightweight partition wall. The inventive jacket tube is easily screwable in such lightweight partition wall, automatically forming a counter-thread in the lightweight partition wall, upon being screwed-in.

The thread height lies in a range of from about 0.5 mm to about 3 mm, preferably from about 0.7 mm to about 2 mm. Thereby, on optimal screw-in behavior in a lightweight partition wall, e.g., in a plaster board or a calcium-silicon board, is achieved.

A thread pitch of 4-26 mm, preferably 5-9 mm also positively influences the screw-in behavior of the inventive jacket tube. The pitch is defined as an axial distance between two adjacent thread crests.

Advantageously, the thread is formed as a trapezoidal thread the thread ribs of which are rounded radially outwardly. This further improves the screw-in behavior, and permits to achieve good holding values of the jacket tube in the opening of the lightweight partition wall. Further, the thread ribs remove little material and insure a high tightness after the jacket tube has been screwed-in in a constructional component.

An optimal sealing against light building boards of a lightweight partition wall is achieved when a distance between two oppositely directed, in an axial direction thread flanks of two opposite thread ribs lies in a range from 8 mm to 30 mm because the light building boards typically have a thickness between 12 mm and 30 mm.

Advantageously, the thread is interrupted in the middle region of the jacket tube, which provides for an easy screw-in of the jacket tube into lightweight partition walls formed of two or more walls.

It is advantageous when the jacket tube has a tool receptacle which permits to connect a tool such as, e.g., a cross-bar or the like, to the jacket tube. The tool facilitates screwing of the jacket tube in a constructional component such as a lightweight partition wall.

It is advantageous when the jacket tube tapers toward its first end in the centering section. This further improves centering of the jacket tube upon screwing it in a pre-formed opening in a constructional component.

The novel features of the present invention which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a perspective view of a leadthrough according to the present invention having a jacket tube; and

FIG. 2 a cross-sectional view of detail II in FIG. 1.

### DETAILED DESCRIPTION OF THE PREFERRED EMBODIMENT

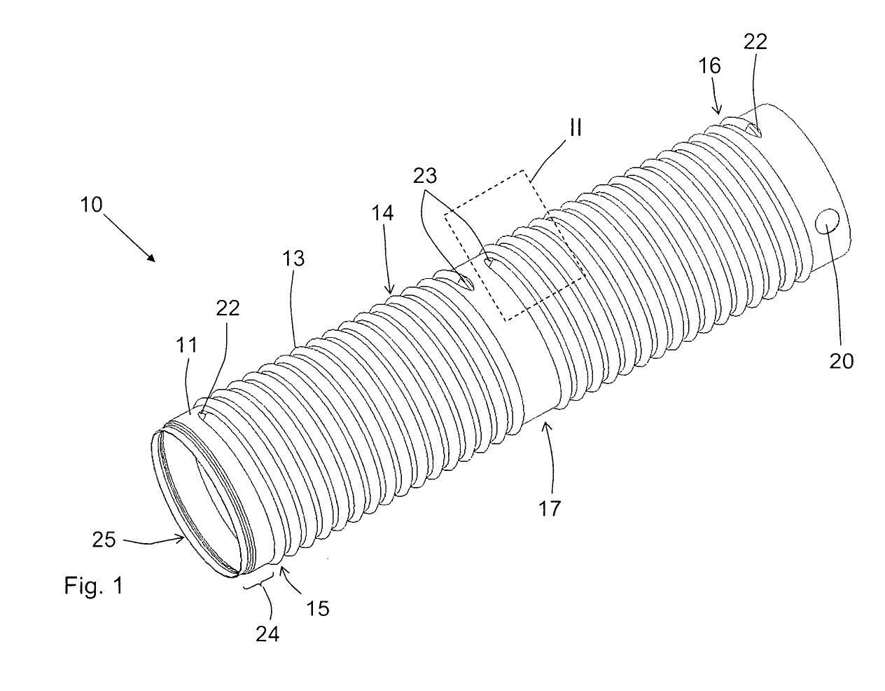

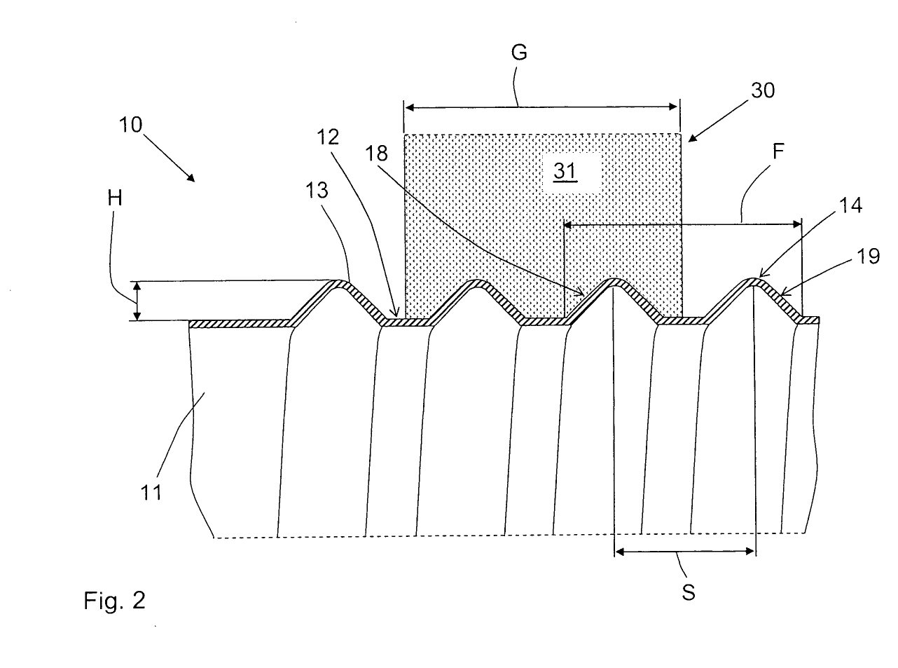

A leadthrough 10 according to the present invention, which is shown in FIGS. 1-2, includes a cylindrical jacket tube 11 that is formed, e.g., of a metal sheet (e.g., steel, stainless steel, galvanized steel sheet) having a thickness of about from 0.1 to 1 mm. On the outer circumference 12 of the jacket tube 11, there is provided a thread-forming thread 13 having a thread height H and which extends from a first axial end region 15 in an axial direction up to a second end region 16. In the first axial region 15, between the thread 13 and a first end 25, there is provided a thread-free centering section 24 that enables an easy insertion and centering of the jacket tube 11 in a pre-formed opening in a constructional component 30. Advantageously, the jacket tube 11 tapers (preferably conically) toward the first end 25 of the jacket tube 11 in the centering section 24. Alternatively, in the centering section 24, there can be provided a centering thread section the thread height of which increases toward the thread 13 and which seamlessly passes into the thread 13.

The thread height H of the thread 13 lies in a range from 0.5 mm to 3 mm, preferably from 0.7 mm to 2 mm, and is 2 mm in the embodiment discussed here.

The thread height H of the thread 13 is reduced in the axial end regions 15, 16 toward the axial thread ends 22, so that the thread 13 becomes ramp-shaped at its outer thread ends 22 over a thread length of at least several mm. The thread 13 is interrupted in the middle region 17 of the jacket tube 11 (i.e., at least one thread turn is missing). Therefore, the inner thread ends 23 adjacent to the thread interruption have increased/decreased thread height, whereby ramp-shaped inner end regions are formed. The thread can naturally be formed continuously, without any interruption. The ramp-shaped, decreasing/increasing thread end (functioning in the screw-in direction as a thread beginning), which is provided in the first axial end region 15 of the jacket tube 11, enables gentle formation of the counter-thread in the lightweight partition wall, without a substantial resistance.

Thread ribs 14 of the thread 13 are trapezoidal and are rounded radially outwardly in order to achieve better screw-in characteristics in openings 17 in lightweight partition plates, e.g., in gypsum plaster boards or calcium silicate boards. The distance F between two oppositely directed, in the axial direction, thread flanks 18, 19 of two opposite, in the axial direction, thread ribs 14 lies in a range from 8 mm to 30 mm. In the embodiment shown in the drawings, the distance F amounts to 12 mm. Further, the thread 13 has a pitch S in a range from 4 mm to 26 m, preferably, from 5 mm to 9 mm, and in the shown embodiment—7 mm.

An optimal sealing against the lightweight partition plate 31 of the constructional component 30 can be achieved because always at least one complete thread turn engages the lightweight partition plate 31 of the constructional component 30.

In the second axial region 16 of the jacket tube 11, there is provided a tool receptacle 20 in form of two opposite openings that serves for receiving a cross-bar that serves as a screw-in tool. With such a screw-in tool, the jacket tube 11 can be screwed in the constructional component 30.

FIG. 2 shows the leadthrough 10 with the jacket tube 11 being already screwed-in in an opening in the constructional component 30 in form of a two-shell lightweight partition wall formed of two, parallel to each other and spaced from each other lightweight partition plates 31. As can be seen in FIG. 2, a complete thread turn (that extends in FIG. 2 between two opposite cut surfaces of the thread rib 14) is engaged with the lightweight partition plate 31 having a thickness b of 15 mm and seals the jacket tube 11 completely against the constructional component 30.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A leadthrough for passing conduits through constructional components, comprising a jacket tube (11); a thread-forming thread (13) provided on an outer circumference (12) of the jacket tube (11), the thread (13) having a thread height (4) and extending from a first axial end region (15) toward a second axial end region (16); and a centering section (24) provided in the first axial end region (15) between the thread (13) and a first end (25) of the jacket tube (11).

2. A leadthrough according to claim 1, wherein the thread height (H) of the thread (13) lies in a range from 0.5 mm to 3 mm.

3. A leadthrough according to claim 2, wherein the thread height (H) of the thread (13) lies in a range from 0.7 mm to 2 mm.

4. A leadthrough according to claim 1, wherein the thread (13) has a pitch (5) in a range from 4 mm to 26 mm.

5. A leadthrough according to claim 4, wherein the pitch (5) of the thread (13) has a pitch in a range of 5 mm to 9 mm.

6. A leadthrough according to claim 1, wherein the thread (13) is formed as a trapezoidal thread and thread ribs thereof are rounded radially outwardly.

7. A leadthrough according to claim 1, wherein a distance (F) between two oppositely directed, in an axial direction, thread flanks (18, 19) of two axially opposite thread ribs (14) lies in a range from 8 mm to 30 mm.

8. A leadthrough according to claim 1, wherein the thread (13) is interrupted in a middle region (17) of the jacket tube (11).

9. A leadthrough according to claim 1, wherein the jacket tube (11) has at least one tool receptacle (20).

10. A leadthrough according to claim 1, wherein the jacket tube (11) tapers toward a first end thereof in the centering section (24).
